(19) United States
(12) Patent Application Publication
(10) Pub. No.: US 2007/0011055 A1
(43) Pub. Date: Jan. 11, 2007

(54) E-commerce with direct access to real-time inventory

(75) Inventor: George Eino Ruul, Applecross (AU)

Correspondence Address: CARR & FERRELL LLP, 2200 GENG ROAD, PALO ALTO, CA, 94303, US

(73) Assignee: NetFire 1 Pty Ltd

(21) Appl. No.: 11/250,996

(22) Filed: Oct. 14, 2005

Related U.S. Application Data
(60) Provisional application No. 60/696,997, filed on Jul. 5, 2005.

(51) Int. Cl. G06Q 30/00

(52) U.S. Cl. 705/26

(57) ABSTRACT

Exemplary systems and methods for e-commerce with direct access to real-time inventory are provided. The system comprises an e-commerce module at a customer site configured to create a product query. The system also comprises a corresponding e-commerce module at one or more vendor sites configured to review the product query and allow access to the coupled inventory database via an open database connection. Because the query is directly into the inventory database of the vendor, product information is in real-time. The request product information is returned to the customer via the customer e-commerce module.

### CROSS REFERENCE TO RELATED APPLICATIONS

The present application claims the priority benefit of Provisional Patent Application Ser. No. 60/696,997, filed Jul. 5, 2005 and entitled “System and Method for Optimized E-Commerce Trading,” which is incorporated herein by reference. The present application is related to U.S. patent application Ser. No. 11/214,515 filed Aug. 29, 2005 for “Managed E-Commerce Trading,” U.S. patent application Ser. No. 11/______ filed September ______, 2005 for “Managed E-Community Trading Environments,” and U.S. patent application Ser. No. 11/______ filed September ______, 2005 for “Content Monitor,” all of which are incorporated herein by reference.

### BACKGROUND OF THE INVENTION

1. Field of the Invention

The present invention relates generally to e-commerce, and more particularly to systems and methods for providing direct access to real-time inventory.

2. Description of Related Art

The Internet has developed into a dominate force in the global business market. Businesses may now sell products, deal with vendors, promote items, sell directly to consumers, and so forth via the Internet. For large companies having resources to set up and maintain websites that offer products for sale along with the mechanisms for contracting the sale, the ability to reach out to consumers is relatively easy. Smaller businesses, however, may not have the capability to do the same.

Typically, businesses list products on its own website for purchasers to access. The product, prices, and availability must be maintained up-to-date on these websites. This is often a time consuming and expensive process which requires some computing expertise.

On the consumer-side, a prospective buyer may visit multiple websites in order to determine the best price for a particular product—a very time consuming process. Alternatively, the buyer may depend on a shopping comparison site to search out the best price. These shopping comparison sites, however, typically only provide dated information obtained from, or “pushed” by, seller websites. Thus, if a seller does not have a website, has not updated their website recently, or has not “pushed” a recent copy of their inventory to a comparison site central database, the information obtained by the consumer may not contain the best price or most updated data available.

FIG. 1A shows one prior art e-commerce network and database architecture 100. As shown, a vendor provides copies of their inventory database 102 information to a central database at a website 104. This website 104 may be a shopping comparison site or a shopping search engine. Oftentimes, the business inventory database 102 is kept on a computing device/system that is not directly connected to the website 104 hosting device. Thus, the vendor must manually move a copy of the inventory database 102 information to a central database at the website 104. Alternatively, a web crawler may gather product information and deposit the information in the central database on the website 104.

A client or buyer 106 may then view this website 104, and query 108 for information on a product of interest. If a product of interest is found, the client may send an order 110 to the website 104. Once the order 110 is fulfilled, the inventory database 102 must be updated. In the present example, the inventory database 102 is manually updated after receipt of an e-mail from the website 106.

Although the above architecture 100 is simple to implement, it is often quite slow and does not cater to having multiple vendors in a transparent manner. Accordingly, an alternative prior art e-commerce architecture 120, as shown in FIG. 1B, may be utilized. This architecture 120 uses ASP (Active Server Pages) type functions to query a vendor database system 122. A result is then returned in a web-based format to the querying client 124. While this architecture 120 may support multiple vendor database systems 122, the network communications are often quite complex, thus resulting in slow communications. Additionally, complex queries across multiple vendor database systems 122 may require extensive network communications which will be extremely slow and inefficient.

A further prior art system 130 is shown in FIG. 1C. In this prior art system 130, an application 132 is embedded into a backend system 134 of the vendor server site 136. Because the application 132 must be embedded into the backend system 134, the overall system is less flexible and more complex to operate. For example, an error with the application 132 may affect other portions of the backend system 134 or a database 138.

Searches conducted on the prior art system 130 of FIG. 1C requires the application 132 to communicate with an ERP/POS system 140 of the backend system 134. That is, the application 132 must query the ERP/POS system 140 to determine pricing, inventory, tax, shipping costs, and other related information. The ERP/POS system 140 in response will access the vendor database 138 to obtain this information.

Disadvantageously, many of these prior art systems do not allow for direct access of real-time inventory of vendor databases. This is especially true of present systems for product searches. Typically, these searches only provide a last known (i.e., last push of data to the central database) price or inventory. These prices and inventories, however, may not be the real-time price and inventory. Therefore, there is a need for a system and method for direct access of real time inventory data.

### SUMMARY

The present invention provides exemplary systems and methods for direct access to real-time inventory in one or more vendor's databases. The exemplary system comprises an e-commerce module at a customer site configured to create a product query. The system also comprises a corresponding e-commerce module at one or more vendor sites configured to receive the customer product query and review the product query.

If access is authorized for the product query the coupled inventory database is search for product query information via an open database connection. In exemplary embodiments, access to the inventory database is given by an invitation sent by the vendor. In one embodiment, the vendor sends a general invitation to a coupled e-commerce server. The general invitation may include a listing of one or more products that the vendor has in their inventory database. When a customer sends a product query for a particular product, the e-commerce server is able to direct the query to the vendor that posted an invitation for the same product.

Alternatively, a product query may be directed to one or more vendors which have not sent general invitations to the e-commerce server. In this embodiment, the vendor after receiving the product query from the customer may send an invitation directly to the customer to access their inventory database.

Because the query is directly into the inventory database of the vendor, product information is in real-time. Once the product information is found, the request product information is returned to the customer via the customer e-commerce module. The customer may then display the product information received from one or more vendors. Should the customer desire to purchase the product, the customer may deal directly with the vendor.

### BRIEF DESCRIPTION OF THE DRAWINGS

FIG. 1A is prior art e-commerce architecture;

FIG. 1B is an alternative prior art e-commerce architecture;

FIG. 1C is a further alternative prior art e-commerce architecture;

FIG. 2 is a simplified, e-commerce architecture in which the present invention may be practiced;

FIG. 3 is an exemplary e-commerce server according to one embodiment;

FIG. 4 is an exemplary direct access product search scenario;

FIG. 5 is an exemplary e-commerce module;

FIG. 6 is a flowchart of an exemplary direct access product search scenario initiated by a customer; and

FIG. 7 is a flowchart of an exemplary direct access product search scenario based on a published invitation.

### DESCRIPTION OF EXEMPLARY EMBODIMENTS

The present invention provides systems and methods for direct access of real-time inventory of one or more vendor databases. Embodiments of the present invention allow a plurality of buyers (e.g., consumers or customers) to access the one or more vendor databases (e.g., retailer) in a real-time e-commerce environment. In exemplary embodiments, the e-commerce environment provides a customer with a direct link with the retailers'/vendors' inventory database, instead of a gigantic, central database. This allows access to the most current inventory and pricing information available to the end user since it is direct from the source (i.e., vendor).

Unlike prior art systems, the present system is scalable; thus, product and inventory data does not need to be centralized or recreated (at a central database website). Instead, existing vendor/retail inventory databases can be “plugged” into embodiments of the present invention without much effort. Further, the present invention provides fast, efficient, and secure communication by using a peer-to-peer model, in some embodiments, over a Virtual Private Network (VPN) which may be monitored. Because the present invention does not rely on HTML/XML browser technology, the present invention requires much less data transfer for information to be sent across the network.

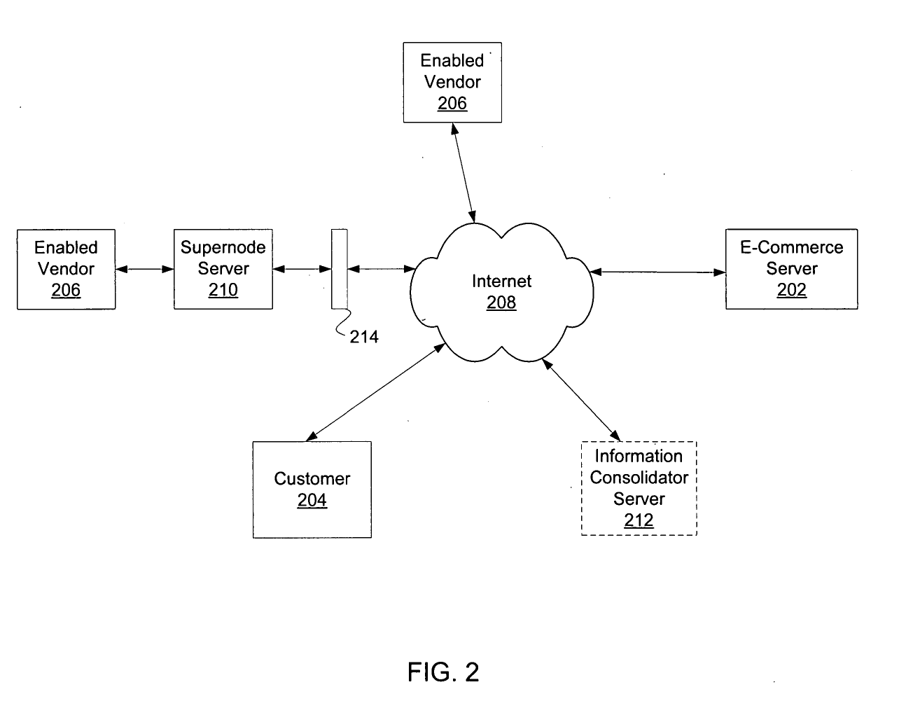

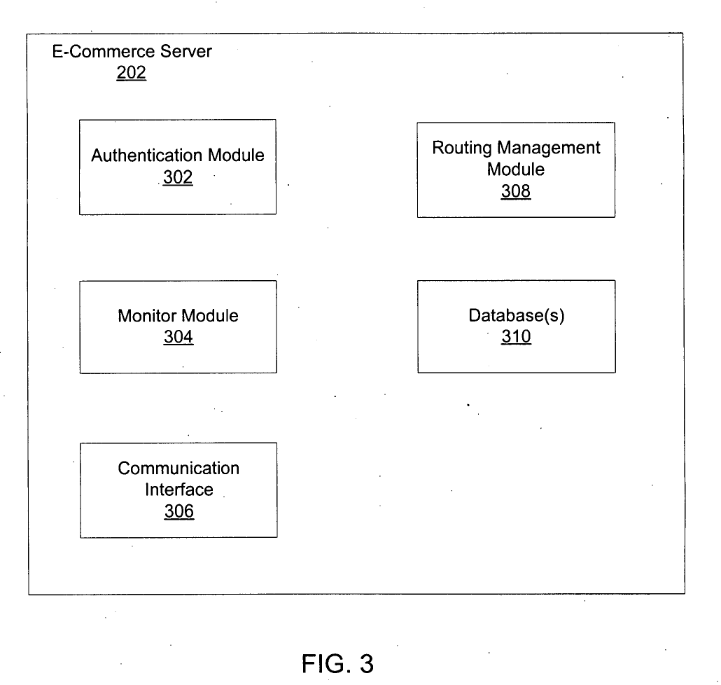

FIG. 2 shows an exemplary e-commerce architecture 200 in which the present invention may be practiced. The architecture 200 comprises various e-commerce components including an e-commerce server 202, at least one customer 204, and one or more enabled vendors 206 all coupled for communication via the Internet 208. An optional supernode server 210 and an optional information consolidator server 212 may also be provided in the e-commerce architecture 200. These e-commerce components allow a plurality of enabled vendors 206 to offer products directly to a plurality of customers 204 accessing the e-commerce system. Plug-ins may be further adapted into the system to customize the system for the vendors 206 and customers 204 as will be described herein. The e-commerce server 202 will be discussed in more detail in connection with FIG. 3.

It should be noted that the architecture 200 of FIG. 2 is exemplary. Alternative embodiments may comprise more or fewer components. For example, more than one information consolidator server 212 or e-commerce server 202 may be provided (e.g., regionally based). Furthermore, any number of vendors 206 and/or customers 204 may be present on the system.

In exemplary embodiments, the system communicates across the Internet 208 using a specialized GUID-over-IP transport mechanism. The specialized transport mechanism allows e-commerce enabled systems to be coupled through a network of internal and external routers, proxies, and firewalls 214 without requiring reconfiguration of the various communications equipment. Routing management allows for control over pathways taken by communicating entities, thus allowing for monitoring to be implemented. This may be an important feature for sensitive communities. Additionally, load balancing and N-tier construction allow for efficient scale out rather than scale up implementations.

Additionally, a non-repudiation protocol may be utilized to insure integrity in the system. For example, origin of data exchanged over the architecture 200 is known and tracked. In one embodiment, electronic certificates may be utilized to guarantee that communications are delivered only to the intended recipient(s), that the transmission is secure, and that the identity of the sender is controlled. Timestamps and encryption keys may also be a part of the non-repudiation protocol. AS2 (Applicability Statement 2) secure transport protocol may, in some embodiments, be utilized to provide the non-repudiation protocol.

In an embodiment where the enabled vendor 206 is located behind the firewall 214, the supernode server 210 may be utilized. Specifically, the supernode server 210 allows a user to communicate through the firewall 214 by directing network traffic through a standard HTTP port (e.g., Port 80). These supernode servers 210 may be deployed within specific trading communities (e.g., privately established set of sellers) or in a common central pool. Thus, the system is scalable for each trading community.

The coupled computing devices of the enabled vendors 206 and the customers 204 may comprise one or more e-commerce modules which allow operation of the present invention and for customization. These client e-commerce modules may include a web server, a software developer kit (SDK), a plug-in coordinator, and a messaging server. The e-commerce module will be discussed in more detail in connection with FIG. 5.

The optional information consolidator server 212 may collect data from one or more enabled user systems. Information may be pushed to the information consolidator server 212 when processing loads on the system is low. The consolidator server 212 may then be used for information analysis (e.g., sales and usage statistics) or as an information broker (i.e., passing data to other systems). In further embodiments, the information consolidator server 212 may additionally, or alternatively, act as a clearing house for data transfers to other coupled Internet systems.

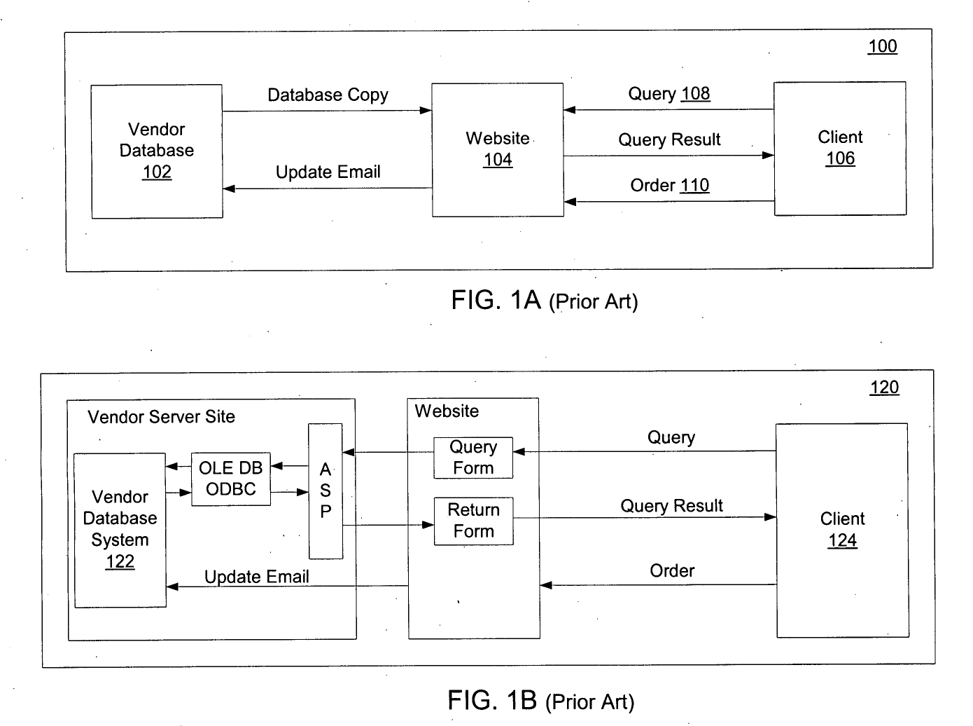

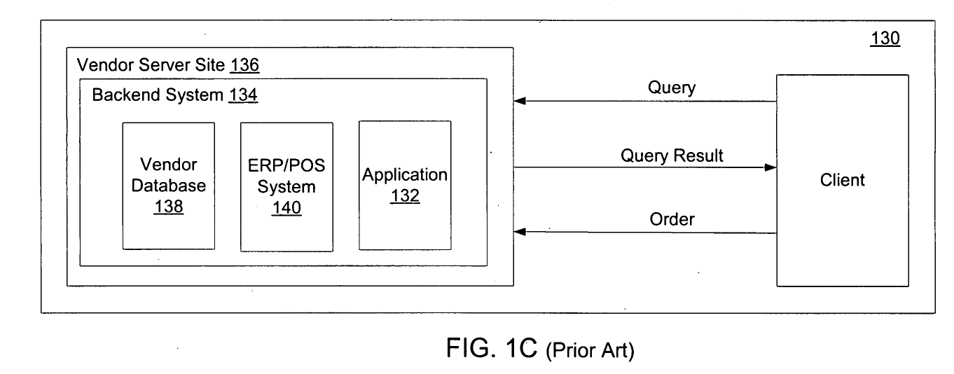

In a further embodiment, a payment gateway may be coupled to the e-commerce system of FIG. 1. The payment gateway adds a financial tie-in (e.g., relationship with financial institutions) to insure payment for any transaction. For example, the payment gateway may couple a credit card provider with the plurality of vendors 206, thus providing vendors with an ability to verify payment prior to shipping of purchased items, for example.

Referring now to FIG. 3, the exemplary e-commerce server 202 is shown in more detail. In exemplary embodiments, the e-commerce server 202 comprises an authentication module 302, a monitor module 304, a communication interface 306, a routing management module 308, and at least one database 310. In further embodiments, the database 310 may comprise a plurality of databases, each storing designated data. For example, the e-commerce server 202 may comprise an authentication database (e.g., containing user information), a monitor database (e.g., storing transaction information), and an e-commerce database (e.g., storing various e-commerce plug-ins and modules that may be accessed and downloaded onto vendor or customer devices). In yet a further embodiment, the e-commerce server 202 is coupled to the database(s) 310 which are located outside of the e-commerce server 202.

The exemplary authentication module 302 authenticates users (both vendors and customers) and their e-communities. When a user first registers with the e-commerce server 202, the user provides user data such as user name, password, and contact information. This information is then stored into the database 310. Authentication may occur seamlessly and unobtrusively to the user. In one embodiment, the authentication process may comprise verifying user names and passwords stored in the database 310. Alternative methods for authenticating users may be utilized, such as verifying IP addresses in communications sent between the parties versus addresses stored in the database 310.

Regardless of the authentication method, the e-commerce server 202 will receive authentication information from the users via the communication interface 306. The authentication module 302 then compares the received authentication information to authentication information stored in the database 310. Therefore, any user accessing or utilizing the system is known to the system and, based on permissions associated with the user, enabled to interact with specified trading community members or the system at large. The authentication may occur during an initial connection with the system (e.g., login at a start of a session). In alternative embodiments, authentication may occur at times other then initial connection, such as when a purchase transaction occurs.

In a further embodiment, the e-commerce server 202 receives copies of some or all packets sent between vendors and customers. The monitor module 304 monitors communications between the vendors 204 and customers 202 via these packet copies. By monitoring communications, integrity (e.g., verifying buyer and sellers) of the system may be insured. In one embodiment, the packet copies are received by the communication interface 306 and stored into the database 310. The monitor module 304 may then review the stored packet copies at any time. Alternatively, the packet copies may be reviewed prior to storing on the database 310.

It should be noted that not all packet copies may be reviewed. Instead, random packets may be reviewed by the monitor module 304. In further embodiments, the monitor module 304 may store all the packets into the database 310 and review packets on-demand. For example, if an issue arises, such as a customer 202 or vendor 204 disputing a particular transaction, the monitor module 304 accesses the database 310 to obtain the transaction information for review. Thus, this embodiment provides for a searchable query, via the monitor module 204, of the stored copies in the database 310. The query may be conducted by the vendor 206, customer 204, a system administrator, or any other authorized individual. Thus, for example, the vendor 206 may communicate with or access the e-commerce server 202 and enter query terms to find a copy of a particular transaction.

Additionally, the monitor module 304 may review and verify different aspects of the copied packet information. In one embodiment, the monitor module 304 reviews and verifies the identities of the customer 202 and vendor 204. In a further embodiment, the monitor module 304 prepares statistical reports based on the content of the copies. For example for a particular vendor, the monitor module 304 can determine how many, how much, and/or when particular products are sold over a certain time period. Statistics may also be determined for a collection of vendors (e.g., a chain store of vendors), between certain vendors, and between certain vendors and customers. For example, a wholesale vendor's transactions with a retailer vendor may be monitored and statistical reports generated thereon. Statistical reports regarding any aspect of transactions between two or more parties (e.g., customers and/or vendors) is within the scope of exemplary embodiments of the present invention.

The statistical reports may then be provided to the vendor 206 or any other user. The statistical reports may be stored in the database 310 for the user to access, be electronically delivered periodically to the user, or delivered via any other means and on any schedule to the user. In one embodiment, the user may access the e-commerce server 202 and via the monitor module 304, input terms for the statistical analysis report.

The exemplary routing management module 308 provides routing instructions that allow for control of pathways taken by communications. In one embodiment, the use of routing instructions allows the system to monitor the communications by routing a copy of the communication packet to the e-commerce server 200.

Alternatively, the communication packets, themselves, may be routed to the e-commerce server 202 prior to their final destination. For example, the routing protocol associated with a communication packet may provide for a third address (wherein the first address is the sender address and the second address is the receiver address). By redirecting the communication packet(s) through the third address (e.g., e-commerce server 202 or an administrator), the system can monitor the communication packet(s).

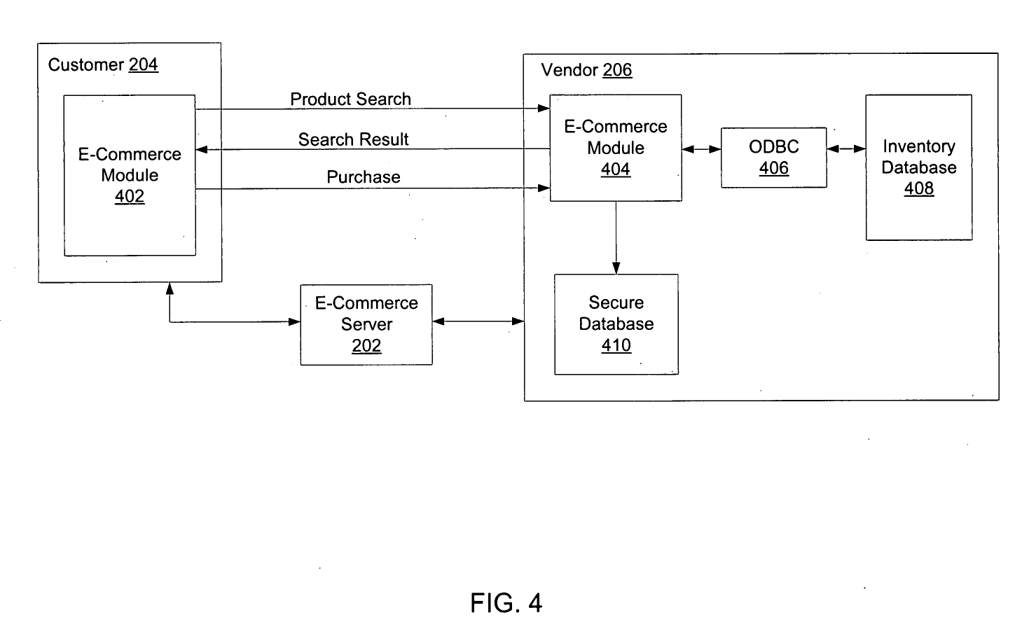

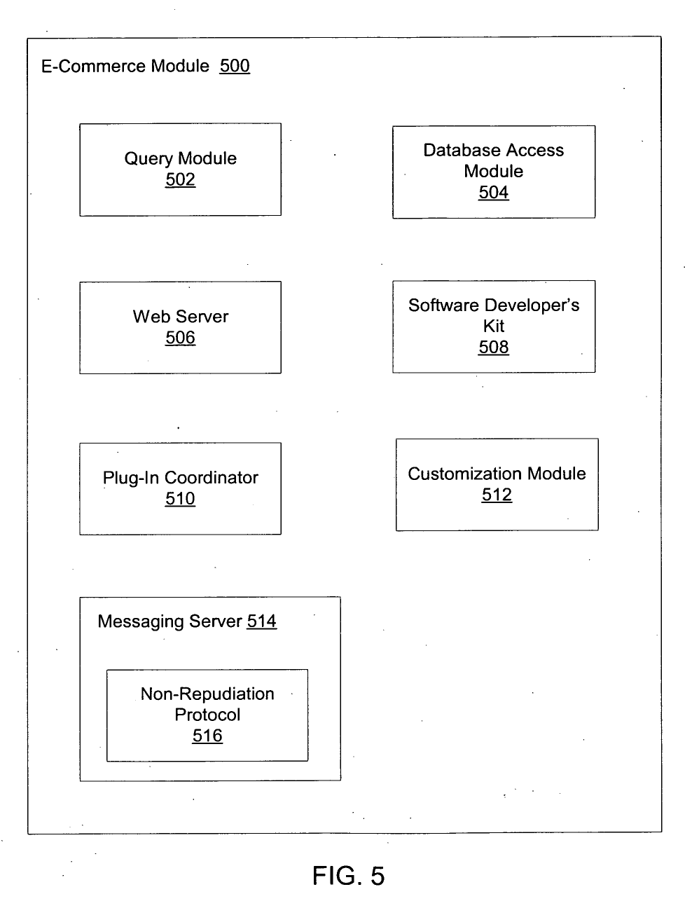

Referring now to FIG. 4, an exemplary management scenario of a direct product search by a customer 204 is shown. The customer 204 may be a user on a computer, a mobile phone or device (e.g., thin clients), or any other wired or wireless computing device that is Internet enabled to allow for product search and purchase via the Internet. In exemplary embodiments, the computing device of the customer 204 has an e-commerce (buyer) module 402 downloaded (from the e-commerce server 202 of FIG. 2) and installed thereon.

As previously discussed, the e-commerce module 402 seamlessly integrates into the customer's computing device. The exemplary e-commerce module 402 may comprise a specialized browser technology optimized for e-commerce communication using the Internet without depending on existing HTML/XML browser technology. In a further embodiment, the e-commerce component 402 allows the customer 204 to set up favorite groups (of sellers) which can be searched, customize their search options, and perform other customization features.

Similarly, the vendor 206 comprises an e-commerce (seller) module 404. When the vendor 206 first registers with the e-commerce server 202 (FIG. 2), the e-commerce (seller) module 404 is downloaded and installed from the e-commerce server 202 onto their computing device. As with the commerce (buyer) module 402, the e-commerce (seller) module 404 may comprise a plug-in that seamless integrates with the vendor's computing device to allow direct access into an inventory database 406. Embodiments of the present invention remove the need for a central database (i.e., the prior art system of FIG. 1a), and instead, forward the query to available peers (i.e., vendors or retailers) to execute a real-time search at the retailer's own inventory database. That is, in one embodiment, back end integration with legacy products utilizing plug-ins of the e-commerce module 404 allows direct access to the inventory database.

If access is authorized for a product query, a coupled inventory database is search for product query information via an open database connection. In exemplary embodiments, access to the inventory database is given by an invitation sent by the vendor. In one embodiment, the vendor sends a general invitation to the coupled e-commerce server 202. The general invitation may include a listing of one or more products that the vendor has in their inventory database. When a customer sends a product query for a particular product, the e-commerce server 202 is able to direct the query to the vendor that posted an invitation for the same product with the e-commerce server 202

Alternatively, a product query may be directed to one or more vendors which have not sent general invitations to the e-commerce server. In this embodiment, the vendor after receiving the product query from the customer may send an invitation directly to the customer to access their inventory database.

In exemplary embodiments, the e-commerce modules 402 and/or 404 comprise a non-repudiation protocol. This non-repudiation protocol insures integrity in the e-commerce environment. For example, the protocol may timestamp communication packets, thus providing a transaction date. In one embodiment, AS2 transport protocol is utilized to provide the non-repudiation protocol.

In the present embodiment, the customer 204 has direct access to, and communicates with, the vendor 206 (the vendor 206 having sent an invitation for access). Thus, the product search query is sent directly to the e-commerce (seller) module 404. The product search query may comprise a search using product codes, (whole, part, or sectional) product descriptions, part numbers, or any other flexible search criteria. Alternatively, the customer 204 may select a product from a (real or virtual) catalog. In yet further embodiments, the product search query may be from a bill of materials or any XML list. For example, the customer 204 creates a list of products they want priced, encapsulates them with XML tags (which may include a list of vendors to query), and forwards this file to the vendor 206. In alternative embodiments, non-XML tags may be utilized. Advantageously, this embodiment allows individuals who may not have a website to sell to their products.

The e-commerce (seller) module 404 receives the query and, via an open database connection (ODBC) 406, the inventory database 408 is searched for the requested information. The inventory database 408 is, in exemplary embodiments, the internal database utilized by the vendor 206 for maintaining their stock. Because the customer 204 can directly query the inventory database 408, the product data is the most current available and there is no need for a centralized database with “pushed” information. The requested information is then sent back via the e-commerce module 404 to the e-commerce (buyer) module 402. If the customer 204 decides to purchase an item from the vendor 206, a purchase communication is sent to the vendor 206.

According to some embodiments, the vendor 206 via the open database connection (ODBC) 406 can simultaneously connect to multiple inventory databases 408. This feature allows the vendor 206 to present a wider range of available products to the customer 204. Additional inventory databases 408 accessed by the vendor 206 may include manufacturer or supplier databases 408. In further embodiments, the vendor 206 can represent different inventories or ranges of available products to different customers 204 based on such criteria as the identity of the customer 204 or the group affiliation of the customer 204. For example, the vendor 206 can represent to one customer 204 a range of available products originating from a single inventory database 408, while representing to a second customer 204 a range of available products originating from multiple inventory databases 408.

In yet other embodiments, the open database connection (ODBC) 406 of the vendor 206 can be supplemented or replaced with an open layer that allows the vendor 206 to communicate other types of information to the customer 204 in addition to or in lieu of inventory or product information. As with inventory or available product information, the particular information communicated by the vendor 206 to the customer 204 can be determined by such criteria as the identity of the customer 204 or the group affiliation of the customer 204.

In exemplary embodiments, copies of the communications between the customer 204 and the vendor 206 may be made by the e-commerce module 404 at the vendor 206. The copies are then sent to the e-commerce server 202 in real time. Alternatively, the copies may be stored in a secure database. The secure database may be at the vendor 206 site or coupled to the vendor 206 on the Internet. Then at a predetermine time or when a predetermined number of copies are stored, the copies are forwarded to the e-commerce server 202 for monitoring purposes. Alternatively at predetermined times, the e-commerce server 202 retrieves the information from the secure database. In yet further embodiments, not all communications are copied. For example, the e-commerce module 404 may only copy communications involving a purchase transaction.

In further embodiments, the e-commerce module 402 at the customer site may also make a copy of the communication packet. The copies are then either stored temporarily at a secure database or sent in real-time to the e-commerce server 202. In yet a further embodiment, copies of communication packets are not made, but instead, the communication packets are redirected through the e-commerce server 202.

Although the embodiment of FIG. 4 shows only one customer 204 coupled in communication with one vendor 206. Embodiments of the present invention allows for one or more customers 204 to couple with one or more vendors 206 at the same time. Thus, for example, the customer 204 may be querying a plurality of vendors 206 simultaneously and obtaining real-time inventory and pricing information back from each vendor 206. This process eliminates the need for the customer 204 to visit multiple vendor websites in order to determine the best price, location, and so forth. Instead, multiple vendor prices and product comparisons may be provided to the customer 204 on a single display screen. Similarly, a vendor 206 may be providing inventory information to a plurality of customers 204 at the same time.

It should be noted that the e-commerce (buyer) module 402 and the e-commerce (seller) module 404 may comprise similar functionalities. This is desirable when a customer 204 may also be a vendor 206. For example, a user may be a wholesale buyer (i.e., customer 204) from a whole seller, and, at the same time, we a retail vendor 206 to individual customers 204.

Referring now to FIG. 5, an exemplary e-commerce module 500 is shown. In exemplary embodiments, the (buyer) e-commerce module (e.g., 402) has the same functionalities as the (seller) e-commerce module (e.g., 404). Therefore the exemplary e-commerce module 500 may comprise some or all of the following components (e.g., depending upon whether the user is a buyer, vendor, or both). In a (seller) e-commerce module 500, a query module 502 reviews queries from customers and responds to customer queries. When a query is received, the query module 502 works with the database access module 504 to obtain the requested information from a coupled database. In a (buyer) e-commerce module 500, the query module 502 generates a query for the customer in a format which will be communicated to one or more vendors. The (buyer) query module 502 also receives results from one or more vendors based on a request generated by the query module 502.

A web server 506 allows web-based interactions with other system installations. An exemplary software developer's kit (SDK) 508 allows use of plug-ins to interface with existing applications and databases, while a plug-in coordinator 510 allows a selectable choice of enabled applications with message marshalling to appropriate applications.

The plug-in coordinator 510 may work with a customization module 512 to allow the user to customize the system (e.g., available services to the end user/customer) via software plug-ins. For example, a vendor 206 may create a plug-in that gives customers 204 access to historical purchasing information or a more sophisticated catalogue. Furthermore, back end integration with legacy products can be achieved with a custom plug-in, such as a plug-in that allows direct access to the vendor's inventory database. The customization module 512 may further allow the user to create a list of preferred customers or buyers as well as to establish relationships with e-communities.

An exemplary messaging server 514 ensures robust communication with other community members with built-in, non-repudiation protocols 516. As previously discussed, the non-repudiation protocols 516 allow for secured transactions to take place in the system.

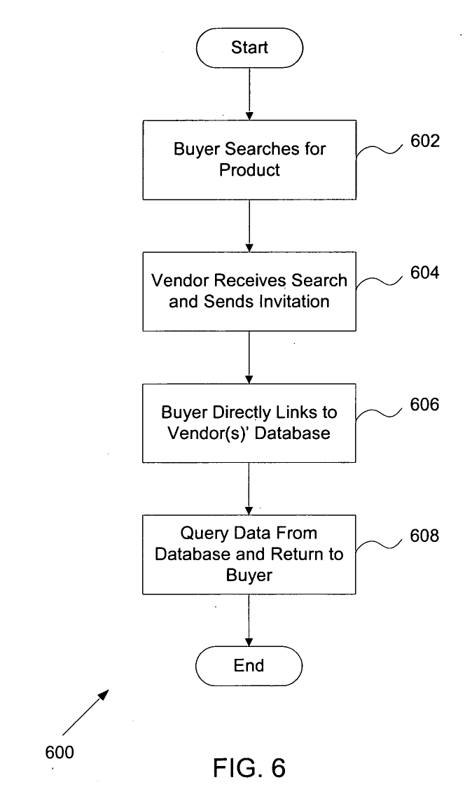

Referring now to FIG. 6, a flowchart of an exemplary direct access product search scenario initiated by a customer is shown. This embodiment allows customer to access source data in real-time and buy directly from the vendor. This provides sales opportunities for both traditional and non-traditional vendors/retailers. Non-traditional vendors may include retailers without websites and individuals such as artists or craftspersons.

In step 602, a buyer/customer searches for a product. According to one embodiment, the customer will use their e-commerce module 402 (FIG. 4), and specifically the query module 502 (FIG. 5) to generate a product search query. As previously discussed, the product search query may comprise a search using product codes, (whole, part, or sectional) product descriptions, part numbers, or any other flexible search criteria. Alternatively, the customer may select a product from a (real or virtual) catalog. In yet further embodiments, the product search query may be from a bill of materials or any XML list. For example, the customer may create a list of products they want priced and encapsulate them with XML tags (which may include a list of vendors to query). In alternative embodiments, non-XML tags may be utilized. Once the query is generated, the query is sent to one or more enabled vendors.

In step 604, one or more vendors receive the query. In exemplary embodiments, the vendor(s) then send an invitation to the customer e-commerce module 402 to access the vendor(s)' database(s). Specifically, the (seller) e-commerce module 404 recognizes the query as one that the vendor is interested in responding to and sends an invitation to the customer e-commerce module 402 to directly access the vendor's database. In one embodiment, the (seller) e-commerce module 404 then authorizes the access for that particular customer via the database access module 504.

In step 606, the customer directly accesses the vendor's database in order to determine real-time inventory, pricing, and other information related to the query. As previously discussed, the query if performed via an open database connection (ODBC) 408 (FIG. 4) to the inventory database (e.g., database 406 of FIG. 4). The database 496 is then searched for the requested information. The inventory database 406 is, in exemplary embodiments, the internal database utilized by the vendor for maintaining their stock.

Results from the query are sent back to the customer in step 608. In exemplary embodiments, the query module 502 formats the results of the query and the messaging server 514 (FIG. 5) forwards the results to the customer.

Should the customer desire to proceed with obtaining the product, the customer e-commerce module 402 communicates with the (seller) e-commerce module 404 to perform the purchase or trade-transaction. For example, in some embodiments, a purchase order is sent by the customer via the e-commerce module 402 to the seller via the e-commerce module 404. A receipt is then sent by the seller to the customer. According to some embodiments, the information contained in the purchase order is exported from the customer e-commerce module 402. The seller e-commerce module 404 stores a copy of the information contained in the purchase order and uses this information for other communications with the buyer, such as for order updates and shipment confirmation.

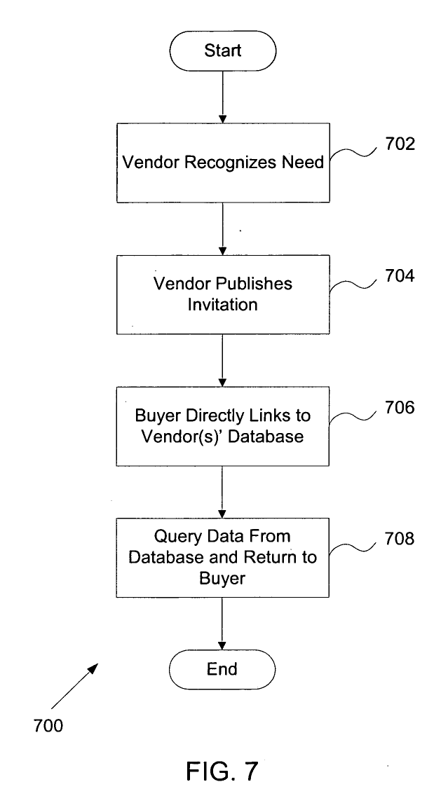

Referring now to FIG. 7, a flowchart 700 of an exemplary direct access product search scenario based on a published invitation is shown. As with the previous embodiment, customer can access source data in real-time and buy directly from the vendor. This embodiment eliminates the need for e-commerce websites and intermediaries, and provides a real-time, direct link between the customer and the vendor allowing the customer to look into the vendor's inventory database in real-time.

In step 702, the vendor recognizes a need for one or more products which the vendor has in their inventory. The vendor then publishes an invitation for customers to access their inventory database to purchase/trade for these products in step 704. The invitation, in exemplary embodiments, is sent to the e-commerce server 202 (FIG. 2). The e-commerce server 202 may forward the invitation to customers searching for the products. In addition, the e-commerce server 202 may keep a list of invitations and products from the inviting vendor.

When a customer is interested in a product available from the vendor, the customer may make a direct link to the vendor's database in step 706. That is, the customer e-commerce module 402 communicates with the e-commerce module 404 of the vendor. The query module 502 identifies the product that the customer is searching for and via the database access module 504, the inventory database is queried to determine availability, pricing, and other related information for the product in step 708. Results of the query are then sent back to the customer via the messaging server 514.

While embodiments of the present invention have been described above in reference to product purchases in an e-commerce environment, embodiments of the present invention may also be practice in non e-commerce environments. For instance, embodiments of the present invention may be practiced in an e-community (i.e., a group of users sharing a common interest) whereby members can query other member databases in order to trade items. One example comprises a stamp collecting e-community. Members of this e-community may list stamps that they are willing to trade in a database. Using the e-commerce module 402 (FIG. 4), a member may search for a particular stamp. The search is performed via a corresponding e-commerce module 404 (FIG. 4) at a trader member site, which provides direct access into the trader member's inventory database. The member may then offer to trade (or purchase) the particular stamp.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

What is claimed is:

1. An e-commerce system having direct access to real-time inventory comprising:
an e-commerce module located at vendor site and coupled to an inventory database, the e-commerce module configured to provide a customer with direct access to the inventory database in real-time.

2. The e-commerce system of claim 1 wherein the e-commerce module comprises a query module configured to review a query received from the customer and generate a response to the query.

3. The e-commerce system of claim 1 wherein the e-commerce module comprises a database access module configured to access the inventory database.

4. The e-commerce system of claim 1 wherein the e-commerce module comprises a messaging server to forward data back to the customer.

5. The e-commerce system of claim 4 wherein the messaging server comprises a non-repudiation protocol to insure integrity of communications between the customer and the vendor.

6. The e-commerce system of claim 1 further comprising a buyer e-commerce module coupled in communication with the e-commerce module, the buyer e-commerce module configured to directly access the vendor inventory database.

7. The e-commerce system of claim 6 wherein the buyer e-commerce module and the e-commerce module are identical.

8. The e-commerce system of claim 1 further comprising an e-commerce server configured to facilitate e-commerce between the customer and the vendor.

9. A method for direct access to real-time inventory in an e-commerce environment comprising:
receiving a product query from at least one customer at an e-commerce module coupled to an inventory database;
via an open database connection, accessing the inventory database for product query information; and
sending the product query information to the at least one customer.

10. The method of claim 9 further comprising publishing an invitation to an e-commerce server.

11. The method of claim 10 wherein the invitation is a virtual catalog.

12. The method of claim 9 further comprising sending an invitation in response to a product search.

13. The method of clam 9 further comprising processing a purchase transaction based on the product query information.

14. The method of claim 9 further comprising authenticating the at least one customer at a coupled e-commerce server.

15. A method for direct access to real-time inventory in an e-commerce environment comprising:
generating a product query at an e-commerce module;
forwarding the product query to at least one vendor;
via an open database connection, accessing an inventory database of the at least one vendor for product query information; and
receiving the product query information from the at least one vendor.

16. The method of clam 15 further comprising accessing an e-commerce server to find invitations from vendors having a product of the product query.

17. The method of claim 15 further comprising awaiting an invitation from the at least one vendor to access the inventory database.

18. The method of claim 15 further comprising displaying one or more product query information received from the at least one vendor.

19. The method of claim 15 further comprising generating a purchase response after receiving the product query information.

20. A computer readable medium having embodied thereon program, the program being executable by a machine to perform a method for direct access to real-time inventory, the method comprising:
receiving a product query from at least one customer at an e-commerce module coupled to an inventory database;
via an open database connection, accessing the inventory database for product query information; and
sending the product query information to the at least one customer.
